(19) United States
(12) Patent Application Publication
(10) Pub. No.: US 2026/0341587 A1
(43) Pub. Date: Oct. 29, 2026

(54) MAGNETIC DEVICE

(71) Applicant: DELTA ELECTRONICS, INC., Taoyuan City (TW)

(72) Inventors: Di ZHU, Shanghai (CN); De-bao QUAN, Shanghai (CN); Chun-Mei WANG, Shanghai (CN); Hai-Jun YANG, Shanghai (CN)

(21) Appl. No.: 19/572,882

(22) Filed: Mar. 20, 2026

(30) Foreign Application Priority Data
Apr. 24, 2025 (CN) 202510523407.0

(51) Int. Cl. H01F 27/32; H01F 27/24

(52) U.S. Cl. CPC H01F 27/325; H01F 27/24

(57) ABSTRACT

A magnetic device includes a magnetic core, a coil portion and a winding bobbin. The magnetic core includes a winding post disposed on the magnetic cover. The coil portion forms an arched structure at a section of the coil portion corresponding to a non-circular arc edge of the winding post, and a first gap is formed between the arched structure and the non-circular arc edge. The winding bobbin includes a sleeve wall. The coil portion is wound around the sleeve wall, which includes an arched portion, a second gap is formed between the arched portion and the non-circular arc edge, a projection of the second gap on the cross section is located within a projection range of the first gap on the cross section, and a glue pouring channel is formed through the second gap between the sleeve wall and the non-circular arc edge.

### CROSS - REFERENCE TO RELATED APPLICATION

This application claims priority to Chinese Application Serial No. 202510523407.0, filed Apr. 24, 2025, the disclosure of which is incorporated herein by reference in its entirety.

### BACKGROUND

### Field of Disclosure

The present disclosure relates to a switching power supply, and more particularly to a magnetic device.

### DESCRIPTION OF RELATED ART

With the rapid development of switching power supply technology in various application fields, more and more power supply products are developing toward higher efficiency, higher power density, smaller size and lower cost.

For high power density magnetic devices, the miniaturization of magnetic devices can be achieved by integrating inductors and transformers. While the magnetic circuit is integrated, the bobbin structure can also be designed as an integrated structure. However, such an integrated structure is often not easy to dissipate heat due to its compactness. If a volume of the integrated structure is increased, such as adding an additional heat sink, it is beneficial to dissipate heat, but it will reduce the integration and the power density as well. In addition, the losses of the magnetic core and coil will be different under different working conditions, such that the heat dissipation of the magnetic core and coil under various working conditions must be taken into account. That is, the high power density magnetic device will have higher requirements for heat dissipation.

Therefore, it is a problem for those skilled in the art need to solve urgently that how to achieve better heat dissipation effect for magnetic devices without increasing an overall volume of the magnetic device and without affecting a performance of the magnetic device.

### SUMMARY

The present disclosure provides a magnetic device to address the problems existing in the prior art.

In one or more embodiments, a magnetic device including: a magnetic core including a magnetic cover and a winding post, wherein the winding post is disposed on the magnetic cover, at least a portion of a cross section of the winding post is a non-circular arc edge, wherein the cross section is perpendicular to an axial direction of the winding post; a coil portion naturally forming an arched structure outward due to a tension applied to a section of the coil portion corresponding to the non-circular arc edge, and a first gap is formed between the arched structure and the non-circular arc edge; and a winding bobbin including a sleeve wall, wherein the sleeve wall defines an inner space configured to accommodate the winding post, the coil portion is wound around the sleeve wall, the sleeve wall includes an arched portion, a second gap is formed between the arched portion and the non-circular arc edge, a projection of the second gap on the cross section is located within a projection range of the first gap on the cross section, and a glue pouring channel is formed through the second gap between the sleeve wall and the non-circular arc edge.

In one or more embodiments, a magnetic device including: a first magnetic core portion, a second magnetic core portion and a third magnetic core portion, the first magnetic core portion and the second magnetic core portion both including a magnetic cover and a winding post, the winding post being disposed on the magnetic cover, at least a portion of the cross section of the winding post being a non-circular arc edge, wherein the cross section is perpendicular to an axial direction of the winding post, and the third magnetic core portion is located between the first magnetic core portion and the second magnetic core portion along the axial direction of the winding post; a coil portion naturally forming an arched structure outward due to a tension applied to a section of the coil portion corresponding to the non-circular arc edge, and a first gap is formed between the arched structure and the non-circular arc edge; and a winding bobbin including a sleeve wall, wherein the sleeve wall defines an inner space configured to accommodate the winding post, the coil portion is wound around the sleeve wall, the sleeve wall includes an arched portion, a second gap is formed between the arched portion and the non-circular arc edge, a projection of the second gap on the cross section is located within a projection range of the first gap on the cross section, and a glue pouring channel is formed through the second gap between the sleeve wall and the non-circular arc edge.

In sum, the present disclosure provides a magnetic device, by setting a non-circular arc edge on a cross section of the magnetic core winding post, a first gap is formed between the arched structure and the non-circular arc edge, which is naturally formed by a tension of the coil portion, and an arched portion is formed on a sleeve wall of the winding bobbin such that a second gap is formed between the arched portion and the non-circular arc edge. A projection of the second gap on the cross section is located within a projection range of the first gap on the cross section, so that the arched portion on the sleeve wall of the winding bobbin utilizes the space of the first gap, thereby creating a glue pouring channel by the second gap between the arched portion and the non-circular arc edge. Therefore, the potting glue can flow smoothly and quickly into an interior of the magnetic device, and enhance the heat dissipation capacity of the magnetic core and the coil portion. It is measured that the magnetic device designed by this scheme can reduce its operating temperature by 5-10° C relative to an ordinary magnetic device structure of the same volume. Therefore, the magnetic device designed by this scheme meets the heat dissipation requirements of high power density magnetic parts without additionally increasing external dimensions of the magnetic device.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as follows:

FIG. 1 illustrates a schematic view of a magnetic device according to an embodiment of the present disclosure;

FIG. 2 illustrates an exploded view of the magnetic device in FIG. 1;

FIG. 3A illustrates a cross-sectional view of the magnetic device in FIG. 1 along section line A-A;

FIG. 3B illustrates a cross-sectional view of the magnetic device in FIG. 1 along section line B-B;

FIG. 4 illustrates a schematic view of a magnetic device according to another embodiment of the present disclosure;

FIG. 5 illustrates a schematic view of a magnetic device according to still another embodiment of the present disclosure;

FIGS. 6A-6C illustrate schematic views of a magnetic device according to still another embodiment of the present disclosure;

FIG. 7 illustrates a schematic view of a magnetic device according to still another embodiment of the present disclosure;

FIG. 8 illustrates a schematic view of the magnetic device in FIG. 7 with the coil portion and the winding bobbin removed; and

FIG. 9 illustrates a schematic view of a magnetic device according to still another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In the description of the present disclosure, unless otherwise expressly specified and limited, the terms “first” and “second” are used for descriptive purposes only and cannot be understood as indicating or implying relative importance; the term “plurality” refers to two or more; the term “and/or” includes any and all combinations of one or more associated listed items. In particular, “the/said” object or “an” object is configured to indicate one of a possible plurality of such objects.

Unless otherwise specified or explained, the terms “connected”, “fixed” and the like should be understood in a broad sense. For example, “connected” can be a fixed connection, a detachable connection, an integral connection, an electrical connection, or a signal connection; “connected” can be a direct connection or an indirect connection through an intermediate medium. For those skilled in the art, the specific meanings of the above terms in the present disclosure can be understood according to the specific circumstances.

Further, in the description of the present disclosure, it should be understood that the directional words such as “upper”, “lower”, “inner”, “outer” and the like described in the exemplary embodiments of the present disclosure are described from the perspectives shown in the accompanying drawings and should not be understood as limitations on the exemplary embodiments of the present disclosure. It is also necessary to understand that, in the context, when it is mentioned that an element or feature is connected to another element (one or more) “on”, “under”, or “inside”, “outside”, it can not only be directly connected to the other (one or more) elements “on”, “under”, “inside”, “outside”, but also indirectly connected to the other (one or more) elements “on”, “under”, or “inside”, “outside” through an intermediate element.

The example embodiments will now be described more fully with reference to the accompanying drawings. However, the example embodiments can be implemented in various forms and should not be construed as being limited to the embodiments set forth herein; on the contrary, these embodiments are provided so that the present disclosure will be comprehensive and complete, and the concept of the example embodiments will be fully conveyed to those skilled in the art. The same reference numerals in the figures represent the same or similar structures, and thus their detailed description will be omitted.

The inventors realized that for the conventional heat dissipation of the magnetic core and the coil, one way is to maintain the cross-sectional area of the magnetic core winding post unchanged, and to increase the space between the bobbin structure and the magnetic core by arranging ribs on an inner side of the bobbin structure, thereby increasing the amount of glue entering the magnetic device. However, such an arrangement will increase an external volume of the product as a whole due to the addition of the ribs. Another way is to eliminate the volume effect caused by the addition of the ribs. One is to offset the space increased by the ribs by compressing the winding space, but this requires using a wire with a smaller cross-sectional area as the coil, which will increase the heat generated by the coil portion. The other is to reduce the cross-sectional area of the magnetic core winding post, and to offset the space increased by the ribs by increasing the space between the magnetic core winding post and the bobbin structure, but this will increase the magnetic flux density of the magnetic core winding post, thereby increasing the risk of magnetic core loss and saturation.

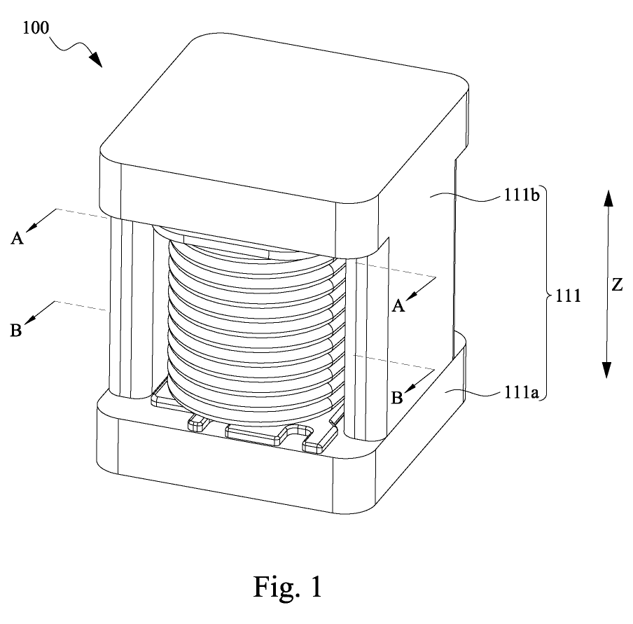

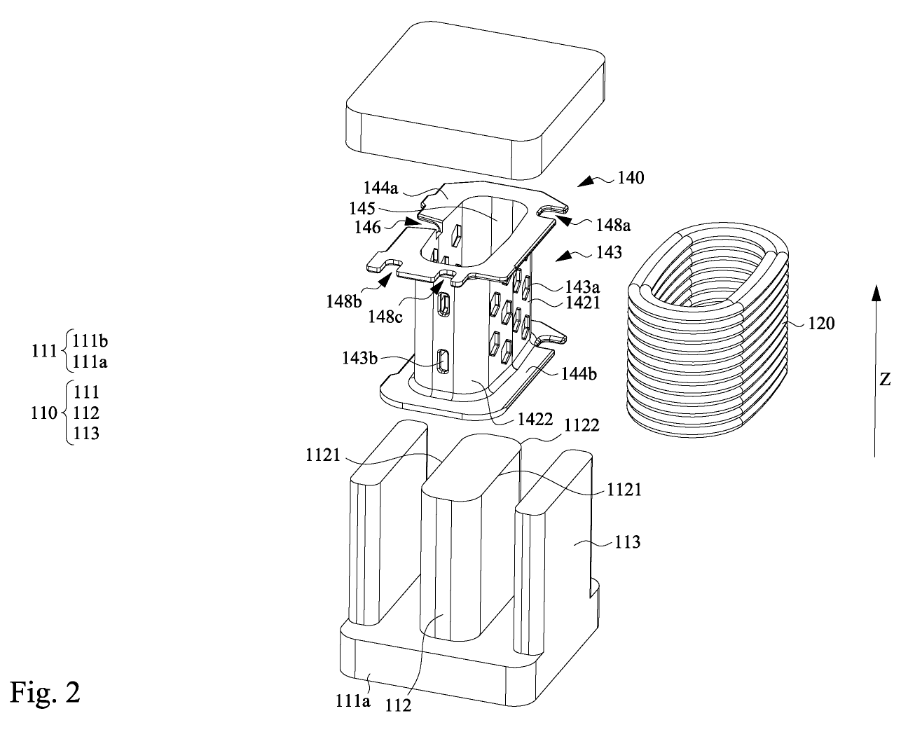

Reference is made to FIGS. 1 and 2, FIG. 1 illustrates a schematic view of a magnetic device 100 according to an embodiment of the present disclosure, and FIG. 2 illustrates an exploded view of the magnetic device 100 in FIG. 1. The magnetic device 100 includes a magnetic core 110, a coil portion 120 and a winding bobbin 140.

The magnetic core 110 includes a magnetic cover 111 and at least one winding post 112. The winding post 112 is disposed on the magnetic cover 111. As shown in FIG. 2, the magnetic cover 111 includes a first magnetic cover 111a and a second magnetic cover 111b, and the winding post 112 is disposed on the first magnetic cover 111a. In some other embodiments of the present disclosure, the winding post 112 can be located on the first magnetic cover 111a and the second magnetic cover 111b at the same time, and the half winding posts 112 on the first magnetic cover 111a and the second magnetic cover 111b are spliced with each other to form a complete one. As shown in FIG. 2, in some embodiments of the present disclosure, the magnetic core 110 also includes at least one side post 113, and the side post 113 is also located on the first magnetic cover 111a. In some other embodiments of the present disclosure, the side post 113 can also be simultaneously located on the first magnetic cover 111a and the second magnetic cover 111b, and the side posts 113 on the first magnetic cover 111a and the second magnetic cover 111b are spliced with each other. As shown in FIG. 2, the magnetic core 110 includes two side posts 113, which are located on opposite sides of the winding post 112 respectively. Along the Z section perpendicular to the axial direction of the winding post 112, such as A-A and B-B shown in FIG. 1, a cross section of the winding post 112 is formed, wherein the cross section of the winding post 112 is at least partially a non-circular arc edge 1121, and as shown in FIG. 2, the non-circular arc edge 1121 is a straight edge.

The coil portion 120 includes at least one coil. When the magnetic device 100 is an inductor, the coil portion 120 includes an inductor coil. When the magnetic device 100 is a transformer, the coil portion 120 includes a primary coil and a secondary coil. The coil may be a three-layer insulated Litz wire or a common Litz wire.

It should be noted that the non-circular arc edge 1121 refers to an edge excluding a circular edge and a circular arc edge (a part of a circle), such as a straight edge or an elliptical arc edge. The purpose of such a setting is to ensure that a first gap S1 is formed between the coil portion 120 and the non-circular arc edge 1121 after the coil portion 120 naturally arches outward due to a tension.

The winding bobbin 140 includes a sleeve wall 142, and the sleeve wall 142 defines an inner space 145 for accommodating the winding post 112, and the coil portion 120 is wound on the sleeve wall 142. In some embodiments of the present disclosure, the winding bobbin 140 includes two winding retaining walls (144a, 144b) located at two end surfaces of the sleeve wall 142 along the axial direction Z. The sleeve wall 142 and the two winding retaining walls (144a, 144b) jointly define a winding region 143 for the coil portion 120 to be wound.

In some embodiments of the present disclosure, at least one of the two winding retaining walls (144a, 144b) is designed with a glue injection opening 146.

In some embodiments of the present disclosure, at least one of the two winding retaining walls (144a, 144b) has at least multiple winding openings (148a-c), and the plurality of winding openings (148a-c) are used to allow a lead-out end of the coil portion 120 to be passed through.

In some embodiments of the present disclosure, the sleeve wall 142 includes at least multiple through holes (143a, 143b), and the plurality of through holes (143a, 143b) is configured to be connected between the inner space 145 and the winding region 143. As shown in FIG. 2, the through holes (143a, 143b) can be designed on the sidewall of the sleeve wall 142 corresponding to, i.e., aligned with, the non-circular arc edge 1121. In some embodiments of the present disclosure, the through holes (143a, 143b) may be circular or polygonal (e.g., triangular, square, hexagonal).

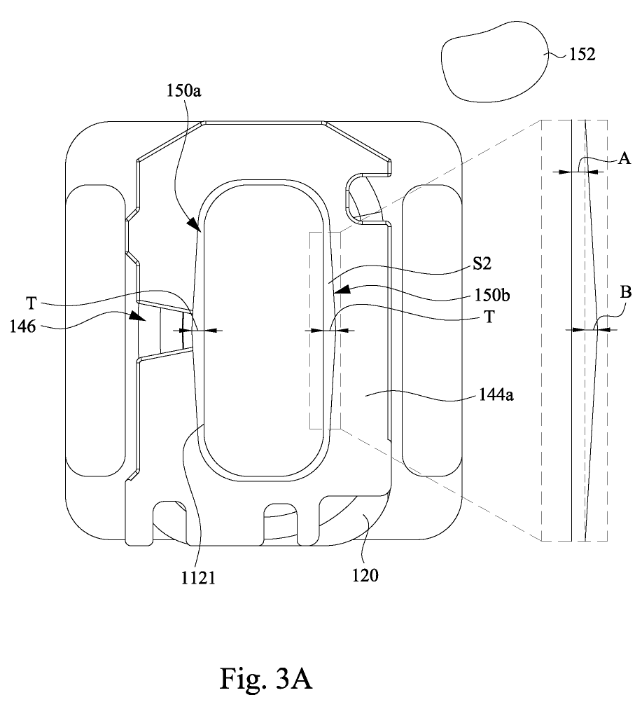

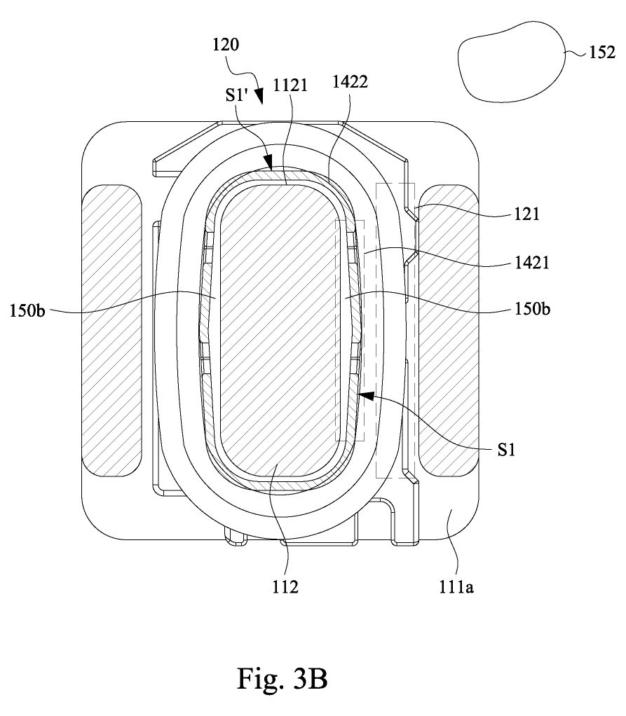

Reference is made to FIGS. 3A-3B, FIG. 3A illustrates a cross-sectional view of the magnetic device 100 in FIG. 1 along section line A-A, and FIG. 3B illustrates a cross-sectional view of the magnetic device 100 in FIG. 1 along section line B-B.

In some embodiments of the present disclosure, the coil portion 120 naturally forms an arched structure 121 outward due to a tension applied to a section of the coil portion corresponding to, i.e., aligned with, the non-circular arc edge 1121 of the winding post 112, and a first gap S1 is formed between the arched structure 121 and the non-circular arc edge 1121. The sleeve wall 142 includes an arched portion 1421, and a second gap S2 is formed between the arched portion 1421 and the non-circular arc edge 1121. A projection of the second gap S2 on the cross section is located within a projection range of the first gap S1 on the cross section. That is, the arched portion 1421 on the sleeve wall 142 of the winding bobbin 140 utilizes the space of the first gap S1. In some embodiments of the present disclosure, a shape of the arched portion 1421 and a shape of the arched structure 121 match each other, so that the coil portion 120 is adjacent to the sleeve wall 142. It should be noted that, due to manufacturing errors, the matching of the shapes of the arched portion 1421 and the arched structure 121 does not necessarily mean that the shapes of the two are exactly the same, as long as the shapes of the two are as similar as possible, so that the coil portion 120 is as close as possible to the sleeve wall 142. As shown in FIG. 2, the winding post 112 can also be designed with an arc-shaped edge 1122, and the sleeve wall 142 also includes a non-arched portion 1422. The shapes of the non-arched portion 1422 and the arc-shaped edge 1122 match each other, further ensuring that the coil portion 120 is in close contact with the sleeve wall 142.

In some embodiments of the present disclosure, as shown in FIG. 3A, at least one glue pouring channel (150a, 150b) is formed between the sleeve wall 142 and the non-circular arc edge 1121 by means of a second gap S2 formed between the arched portion 1421 and the non-circular arc edge 1121. A maximum width T of the glue pouring channel (150a, 150b) is A+B, where A is an assembly gap reserved between the sleeve wall 142 and the winding post 112, and B is a maximum gap of the arched portion 1421 arched outward relative to the assembly gap A.

In some embodiments of the present disclosure, the maximum gap B is greater than or equal to 0.5 mm. The glue pouring channels (150a, 150b) are used for at least partially allowing a potting glue 152 to pass through. The potting glue 152 has a viscosity less than or equal to 25 Pa·s, thereby quickly flowing into an interior of the product through the glue pouring channels (150a, 150b) to enhance the heat dissipation capability of the magnetic core 110 and the coil portion 120.

In some embodiments of the present disclosure, as shown in FIG. 3A, the shape of the arched portion 1421 may be a triangle. In this case, the arched structure 121 of the coil portion 120 is still in an arc shape. However, since the non-circular arc edge 1121 is a straight edge, and the length of the straight edge is relatively long, the arched structure 121 in an arc shape is similar to a triangular edge visually, so the shape of the arched portion 1421 is set to be a triangle. In other embodiments of the present disclosure, the shape of the arched portion 1421 may also be an arc shape, as long as the projection of the second gap S2 on the cross section is within the projection range of the first gap S1 on the cross section. Referring to FIG. 3B, it can be seen that the number of arched portions 1421 of the sleeve wall 142 is less than or equal to the number of non-circular arc edges 1121 of the winding post 112. Therefore, the arched portions 1421 of the sleeve wall 142 can be flexibly designed according to actual needs and the size of the first gap S1 formed between the coil portion 120 and the non-circular arc edges 1121 after the coil portion 120 naturally arches outward due to the tension. As shown in FIG. 3B , since one of the non-circular arc edges 1121 of the winding post 112 is shorter, the first gap S1’ formed between the coil portion 120 and the non-circular arc edges 1121 is smaller after the coil portion 120 naturally arches outward due to the tension. Therefore, the arched portion 1421 may not be designed corresponding to the sleeve wall 142, but a non-arched portion 1422 may be designed corresponding to the sleeve wall 142. Accordingly, at least multiple non-circular arc edges 1121 may be designed on the cross section of the winding post 112 to increase the number of the glue pouring channels (150a, 150b), thereby further increasing the heat dissipation capability of the magnetic device 100.

In some embodiments of the present disclosure, a glue injection opening 146 can be formed on at least one of the two winding retaining walls (144a, 144b). The glue injection opening 146 can be located at a position of the two winding retaining walls (144a, 144b) that is close to at least one non-circular arc edge 1121 of the winding post 112, and connected to the glue pouring channel (150a, 150b), thereby introducing the potting glue 152 into the glue pouring channel (150a, 150b) through the glue injection opening 146, thereby accelerating the filling speed of the potting glue 152. In addition, the through holes (143a, 143b) allow the potting glue 152 in the glue pouring channel (150a, 150b) to be flown into the coil portion 120 through the through holes (143a, 143b), thereby enhancing the heat dissipation capacity of the coil portion 120 and balancing the heat exchange between the magnetic core 110 and the coil portion 120 under different working conditions. Therefore, the winding bobbin 140 of the present disclosure can meet the heat dissipation requirements of the high power density magnetic device without additionally increasing an external dimension of the magnetic device 100.

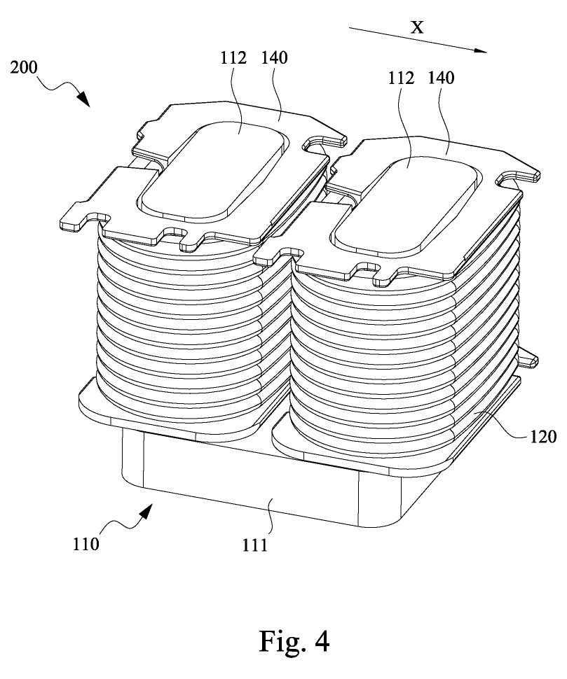

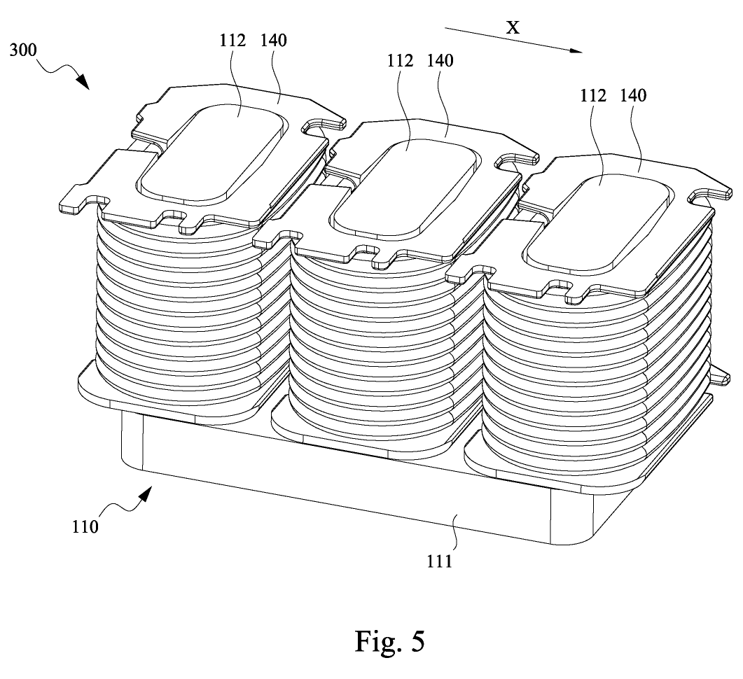

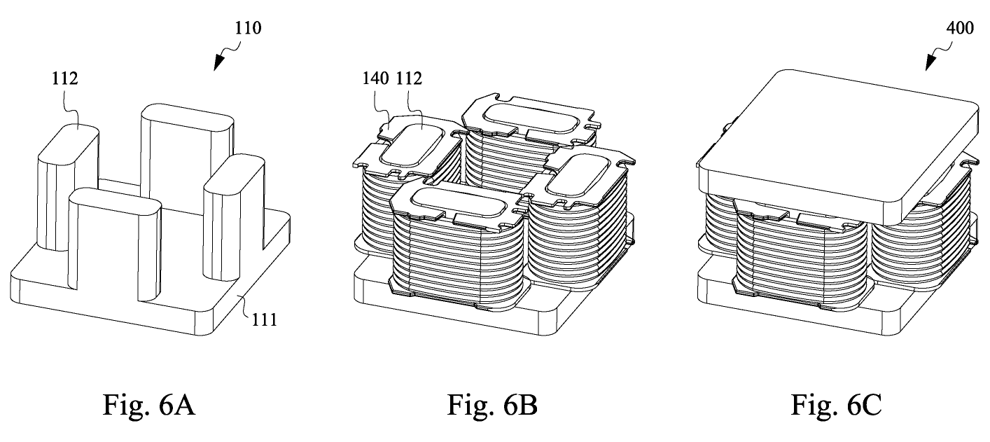

Reference is made to FIGS. 4-6C. FIG. 4 illustrates a schematic view of a magnetic device 200 with two winding posts, FIG. 5 illustrates a schematic view of a magnetic device 300 with three winding posts, and FIGS. 6A-6C illustrate schematic views of a magnetic device 400 with four winding posts. For ease of illustration, the magnetic cover 111 on the upper side of the magnetic core 110 is omitted in FIGS. 4, 5, 6A, and 6B. In some embodiments of the present disclosure, the magnetic core 110 may include at least multiple winding posts 112. As shown in FIG. 4, the magnetic core 110 of the magnetic device 200 has two winding posts 112 sequentially located on the magnetic cover 111 along the first direction X. As shown in FIG. 5, the magnetic core 110 of the magnetic device 300 has three winding posts 112 sequentially located on the magnetic cover 111 along the first direction X. The embodiments shown in FIGS. 4 and 5 are substantially the same in design as the winding bobbin 140 and the coil portion 120 of the embodiments shown in FIGS. 1-3B, and are not described in detail herein. It is noted that when the magnetic core 110 includes four or more winding posts 112, these winding posts 112 may be sequentially located on the magnetic cover 111 along the first direction X. In other embodiments of the present disclosure, the winding posts 112 may not be sequentially arranged on the magnetic cover 111 along the first direction X. In the embodiment shown in FIGS. 6A-6C, the magnetic core 110 of the magnetic device 400 has four winding posts 112, and the four winding posts 112 are respectively arranged on four sides of the magnetic cover 111. It is noted that the winding bobbin 140 described in the present disclosure can be applied to a variety of magnetic cores, including but not limited to a multi-winding post magnetic device similar to those shown in FIGS. 4, 5, and 6A-6C .

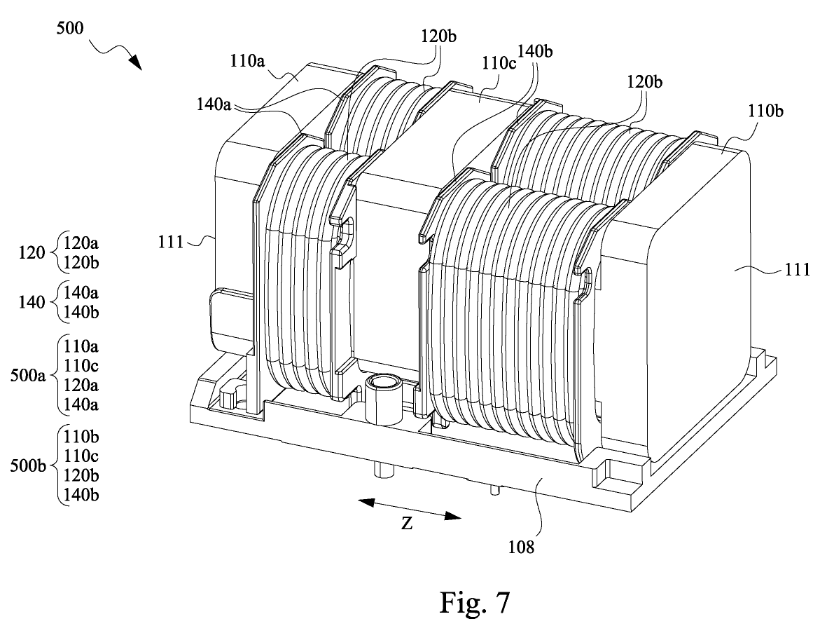

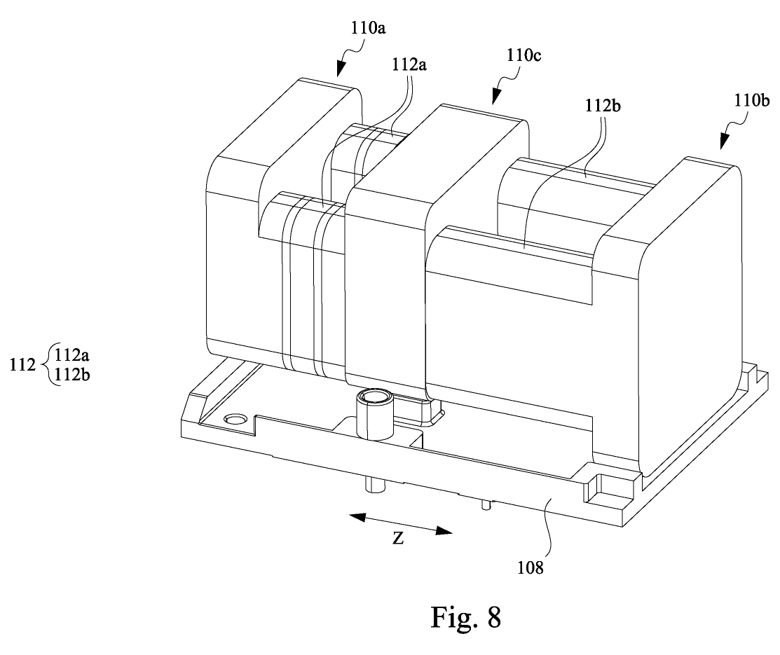

Reference is made to FIGS. 7-8, FIG. 7 illustrates a schematic view of a magnetic device 500 according to still another embodiment of the present disclosure, FIG. 8 illustrates a schematic view of the magnetic device 500 in FIG. 7 with the coil portion and the winding bobbin removed. The magnetic device 500 includes a first magnetic core portion 110a, a second magnetic core portion 110b, and a third magnetic core portion 110c. The first magnetic core portion 110a and the second magnetic core portion 110b both include a magnetic cover 111 and two winding posts 112. In other embodiments of the present disclosure, the first magnetic core portion 110a and the second magnetic core portion 110b may also include only one winding post 112. The cross-sections of the two winding posts 112 may be the same as the winding post 112 of the embodiment shown in FIGS. 1-3B, and along the axial direction Z of the winding post 112, the third magnetic core portion 110c is located between the first magnetic core portion 110a and the second magnetic core portion 110b. The winding bobbin 140 and the coil portion 120 of the embodiment shown in FIGS. 7-8 are substantially the same in design as the winding bobbin 140 and the coil portion 120 of the embodiment shown in FIGS. 1-3B.

In some embodiments of the present disclosure, the magnetic device 500 is an integrated magnetic device of an inductor 500a and a transformer 500b. The coil portion 120 includes an inductor coil 120a and a transformer coil 120b, the winding bobbin 140 includes an inductor bobbin 140a and a transformer bobbin 140b, and the winding post 112 includes an inductor winding post 112a and a transformer winding post 112b, which are located on the magnetic cover 111 of the first magnetic core portion 110a and the second magnetic core portion 110b respectively. The first magnetic core portion 110a, the inductor bobbin 140a, the inductor coil 120a and the third magnetic core portion 110c collectively constitute an inductor 500a, and the second magnetic core portion 110b, the transformer bobbin 140b, the transformer coil 120b and the third magnetic core portion 110c collectively constitute a transformer 500b. The inductor 500a and the transformer 500b are fixed on the base 108.

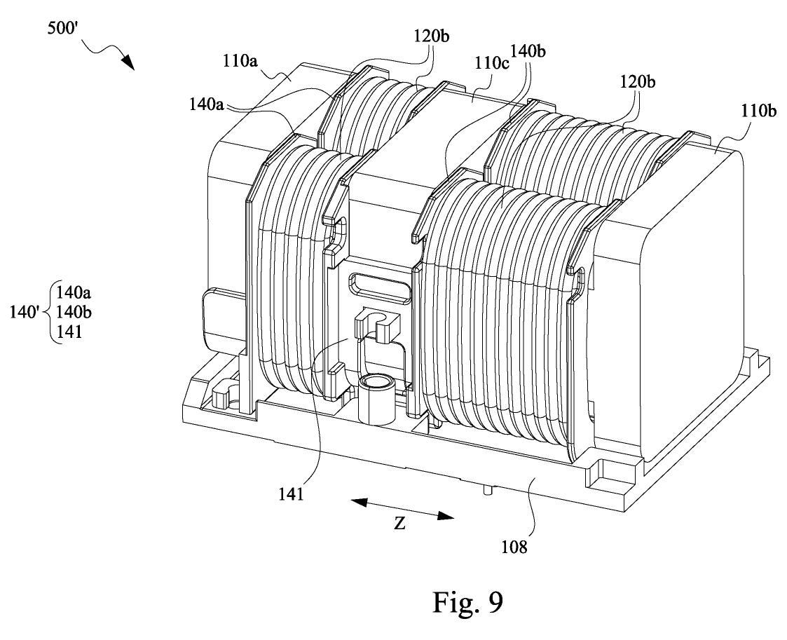

Reference is made to FIG. 9, which illustrates a schematic view of a magnetic device 500’ according to still another embodiment of the present disclosure. The difference between magnetic device 500’ and magnetic device 500 is mainly in the different structures of the winding bobbin. The winding bobbin 140’ includes an inductor bobbin 140a, a transformer bobbin 140b and a connecting rib 141. The connecting rib 141 integrates the inductor bobbin 140a and the transformer bobbin 140b into a unitary one. While the magnetic coil is integrated, the winding bobbin can also be integrated. The inductor coil 120a and the transformer coil 120b can be automatically wound together. The wire groove on the connecting rib 141 between the inductor bobbin 140a and the transformer bobbin 140b can play an important role in organizing and restricting the coil wire in the automatic winding. The third magnetic core portion 110c is arranged at a position aligned with or corresponding to the connecting rib 141.

In sum, the present disclosure provides a magnetic device, by setting a non-circular arc edge on a cross section of the magnetic core winding post, a first gap is formed between the arched structure and the non-circular arc edge, which is naturally formed by a tension of the coil portion, and an arched portion is formed on a sleeve wall of the winding bobbin such that a second gap is formed between the arched portion and the non-circular arc edge. A projection of the second gap on the cross section is located within a projection range of the first gap on the cross section, so that the arched portion on the sleeve wall of the winding bobbin utilizes the space of the first gap, thereby creating a glue pouring channel by the second gap between the arched portion and the non-circular arc edge. Therefore, the potting glue can flow smoothly and quickly into an interior of the magnetic device, and enhance the heat dissipation capacity of the magnetic core and the coil portion. It is measured that the magnetic device designed by this scheme can reduce its operating temperature by 5-10°C relative to an ordinary magnetic device structure of the same volume. Therefore, the magnetic device designed by this scheme meets the heat dissipation requirements of high power density magnetic parts without additionally increasing external dimensions of the magnetic device.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A magnetic device comprising:
a magnetic core comprising a magnetic cover and a winding post, wherein the winding post is disposed on the magnetic cover, at least a portion of a cross section of the winding post is a non-circular arc edge, wherein the cross section is perpendicular to an axial direction of the winding post;
a coil portion naturally forming an arched structure outward due to a tension applied to a section of the coil portion corresponding to the non-circular arc edge, and a first gap is formed between the arched structure and the non-circular arc edge; and
a winding bobbin comprising a sleeve wall, wherein the sleeve wall defines an inner space configured to accommodate the winding post, the coil portion is wound around the sleeve wall, the sleeve wall comprises an arched portion, a second gap is formed between the arched portion and the non-circular arc edge, a projection of the second gap on the cross section is located within a projection range of the first gap on the cross section, and a glue pouring channel is formed through the second gap between the sleeve wall and the non-circular arc edge.

2. The magnetic device of claim 1, wherein the non-circular arc edge is a straight line edge or an elliptical arc edge.

3. The magnetic device of claim 1, wherein a maximum width of the glue pouring channel is T=A+B, wherein A is an assembly gap reserved between the sleeve wall and the winding post, and B is a maximum gap of the arched portion arching outward relative to A.

4. The magnetic device of claim 3, wherein B is greater than or equal to 0.5 mm.

5. The magnetic device of claim 3, further comprising a potting glue at least partially passing through the glue pouring channel, wherein a viscosity of the potting glue is less than or equal to 25Pa·s.

6. The magnetic device of claim 4, further comprising a potting glue at least partially passing through the glue pouring channel, wherein a viscosity of the potting glue is less than or equal to 25Pa·s.

7. The magnetic device of claim 1, wherein a shape of the arched portion is an arc or a triangle.

8. The magnetic device of claim 1, wherein a number of the arched portion is less than or equal to a number of the non-circular arc edge.

9. The magnetic device of claim 1, wherein the winding bobbin comprises two winding retaining walls disposed oppositely at two end surfaces of the sleeve wall in the axial direction of the winding post, and the sleeve wall and the two winding retaining walls jointly define a winding region for the coil portion to be wound.

10. The magnetic device of claim 9, wherein the sleeve wall comprises a plurality of through holes configured to be connected between the inner space and the winding region.

11. The magnetic device of claim 10, wherein a shape of each through hole is circular or polygonal.

12. The magnetic device of claim 9, wherein at least one of the two winding retaining walls has a glue injection opening.

13. The magnetic device of claim 12, wherein the glue injection opening is located in an area of the two winding retaining walls adjacent to the non-circular arc edge.

14. The magnetic device of claim 12, wherein the glue injection opening is connected to the glue pouring channel.

15. The magnetic device of claim 11, wherein at least one of the two winding retaining walls has a plurality of winding openings configured for a lead-out end of the coil portion to be passed through.

16. The magnetic device of claim 1, wherein the magnetic core comprises a plurality of the winding posts.

17. A magnetic device comprising:
a first magnetic core portion, a second magnetic core portion and a third magnetic core portion, the first magnetic core portion and the second magnetic core portion both comprising a magnetic cover and a winding post, the winding post being disposed on the magnetic cover, at least a portion of a cross section of the winding post being a non-circular arc edge, wherein the cross section is perpendicular to an axial direction of the winding post, and the third magnetic core portion is located between the first magnetic core portion and the second magnetic core portion along the axial direction of the winding post;
a coil portion naturally forming an arched structure outward due to a tension applied to a section of the coil portion corresponding to the non-circular arc edge, and a first gap is formed between the arched structure and the non-circular arc edge; and
a winding bobbin comprising a sleeve wall, wherein the sleeve wall defines an inner space configured to accommodate the winding post, the coil portion is wound around the sleeve wall, the sleeve wall comprises an arched portion, a second gap is formed between the arched portion and the non-circular arc edge, a projection of the second gap on the cross section is located within a projection range of the first gap on the cross section, and a glue pouring channel is formed through the second gap between the sleeve wall and the non-circular arc edge.

18. The magnetic device of claim 17, wherein the magnetic device is an integrated magnetic device of an inductor and a transformer, wherein the coil portion comprises an inductor coil and a transformer coil, the winding bobbin comprises an inductor bobbin and a transformer bobbin, the winding post comprises an inductor winding post and a transformer winding post, which are disposed on the magnetic cover of the first magnetic core portion and the magnetic cover of the second magnetic core portion respectively, wherein the first magnetic core portion, the inductor bobbin, the inductor coil and the third magnetic core portion collectively constitute the inductor, and wherein the second magnetic core portion, the transformer bobbin, the transformer coil and the third magnetic core portion collectively constitute the transformer.

19. The magnetic device of claim 18, wherein the inductor bobbin and the transformer bobbin are fixedly connected by a connecting rib, and the third magnetic core portion is disposed at a position corresponding to the connecting rib.
